(19) United States
(12) Patent Application Publication
(10) Pub. No.: US 2010/0248388 A1
(43) Pub. Date: Sep. 30, 2010

(54) Solid Phase Extraction and Ionization Device

(75) Inventors: Baohong Liu, Shanghai (CN); Qiao Liang, Wuan (CN); Niels Lion, Lausanne (CH); Jingjing Wan, Shanghai (CN); Michel Prudent, Les Hopitaux Neufs (FR); Christophe Roussel, Pontarlier (FR); Pengyuan Yang, Shanghai (CN); Hubert Hugues Girault, Ropraz (CH)

Correspondence Address: HOWSON & HOWSON LLP, 501 OFFICE CENTER DRIVE, SUITE 210, FORT WASHINGTON, PA, 19034, US

(73) Assignee: ECOLE POLYTECHNIQUE FEDERALE DE LAUSANNE, Lausanne (CH)

(21) Appl. No.: 12/667,281

(22) PCT Filed: Jul. 1, 2008
(86) PCT No.: PCT/EP08/05347

§ 371 Date: Jun. 11, 2010

(30) Foreign Application Priority Data
Jul. 2, 2007 (GB) 0712795.4

(51) Int. Cl. G01N 24/00; B05D 5/12; H05H 1/24; B01J 19/08; G01N 30/00

(52) U.S. Cl. 436/173; 427/58; 427/569; 427/457; 422/69; 977/773

(57) ABSTRACT

A plate for laser desorption ionization mass spectrometry comprising an electrically conductive substrate (1) covered with an array of spots of sintered nanoparticles (2) acting as a highly efficient sorbing phase, a very sensitive photo-reactive phase and an ionization device when covered by an organic matrix or by a hole conductor or electron donor instead of an organic matrix.

### BACKGROUND OF THE INVENTION

The present invention relates to a Laser-Desorption-Ionization (LDI) target plate where the conductive substrate is covered in defined locations by a layer of sintered nanoparticles. This adherent layer is used first as a large specific surface area solid phase on a small geometric area on the plate, therebelow called a spot, to sorb, i.e. adsorb or absorb, a sample. When molecules from the sample specifically interact with the nanoparticles, the sintered nanoparticles layer can be used as an extractor phase to concentrate these molecules on the spot. When the nanoparticles absorb light from the laser source and are photosensitized, the spot can be used as a photo-reactive phase to oxidize or reduce molecules from the sample or added to the sample. In all cases, the spot acts as a support phase for the ionization of the sorbed molecules from the sample for their analysis by mass spectrometry, for the ionization of the specifically interacting molecules from the sample for their analysis by mass spectrometry and/or for the ionization of the products of the photo-induced charge transfer reactions for their analysis by mass spectrometry with or without the help of an organic matrix.

As one of the most important LDI techniques, matrix-assisted-laser-desorption-ionization (MALDI) is a standard ionization technique to transfer globally neutral solid-state samples, in particular containing biomolecules, to gas-phase ions for further analysis by a mass spectrometer. MALDI ionization is such a general ionization technique that it has been applied to a wide range of biomolecules such as peptides and proteins, DNA [G. Corona and G. Toffoli, Comb. Chem. High Throughput Screen, 7 (2004) 707; C. Jurinke, P. Oeth and D. Van Den Boom, App. Biochem. Biotechnol. B, 26 (2004) 147; J. Ragoussis, G. P. Elvidge, K. Kaur and S. Colella, PLoS Genetics, 2 (2006) 0920], glycans and glycoconjugates [D. J. Harvey, Mass Spectrom. Rev., 18 (1999) 349; D. J. Harvey, Proteomics, 5 (2005) 1774; D. J. Harvey, Mass Spectrom. Rev., 25 (2006) 595], lipids [M. Pulfer and R. C. Murphy, Mass Spec. Rev., 22 (2003) 332; J. Schiller, J. Arnhold, S. Benard, M. Muller, S. Reichl and K. Arnold, Anal. Biochem., 267 (1999) 46] and coupled to various types of mass analyzers, such as ion traps (IT), time-of-flight (TOF), quadrupole-time-of-flight (Q-TOF), Fourier-transform Ion Cyclotron Resonance (FT-ICR).

The principle of MALDI ionization lies in the absorption of laser energy by an acidic crystalline matrix mixed with the sample or covering the sample to be analyzed. Upon energy absorption by the matrix, both matrix and analyte molecules are desorbed from the target plate, and charge transfer reactions occur in the MALDI plume, which finally leads to gas-phase analyte ions that can be analyzed by the mass spectrometer [R. Knochenmuss, Analyst, 131 (2006) 966]. Whereas MALDI is a soft ionization technique that usually produces intact, singly-charged biomolecular ions, using a higher laser fluence increases the internal energy of protein ions; when ions are allowed to decay in the MALDI source before being accelerated and injected in the time-of-flight analyzer, as is typically the case when delayed extraction is used, fragmentation of protein ions occur directly in the source, in typically less than 100 nanoseconds [J. Hardouin, Mass Spectrom. Rev., 26 (2007) 672]. This so-called in-source decay (ISD) generally results in the cleavage of the N—C_{α} bond of the peptidic backbone, producing cₙ and zₙ₊₂ fragment types [M. Takayama, J. Am. Soc. Mass Spectrom. 12 (2001) 420]. The mechanism at work in ISD seems to be i) an electronic excitation of the matrix by photon absorption ii) an intermolecular hydrogen transfer from the matrix to the peptide backbone iii) the formation of a peptide radical and iv) the cleavage of the NH—CH bond [M. Takayama, Int. J. Mass Spectrom. 181 (1998) L1; M. Takayama, J. Amer. Soc. Mass Spectrom., 12 (2001) 1044; T. Kocher, Anal. Chem. 77 (2005) 172]. ISD fragmentation can be typically used to sequence part of a protein sequence (typically a few tens of amino acids), and thus identify the protein of interest through database query [D. Reiber, Anal. Chem. 70 (1998) 673], identify post-translational modification sites such as phosphorylation, because side-chain modifications are preserved during ISD [T. Kinumi, Anal. Biochem., 277 (2000) 177; J. Lennon, Protein Sci. 8 (1999) 2487], or differentiate oligosaccharide structural isomers [T. Yamagaki, J. Mass Spectrom. 35 (2000) 1300].

Several alternative plates/matrices have been introduced over the recent years to add additional functions to target plates, e.g. plates covered with specific solid-phases presenting different affinities for targeted biomolecules: for example, Ciphergen has introduced polymer-coated plates that present different affinities for proteins, based on ion exchange and reverse-phase mechanisms. When the different surfaces are exposed to the sample, different proteins are adsorbed to different surfaces; non-retained proteins and co-solvents can be washed out [G. L. Wright, L. H. Cazares, S. M. Leung, S, Nasim, B. L. Adam, T. T. Yip, P. F. Schellhammer, L. Gong and A. Vlahou, Prost. Cancer Prost. Diseases, 2 (1999) 264]. Due to the intrinsic properties of the polymer used, a laser can be directly shot on the polymeric surface, resulting in retained-analyte desorption and ionization. Alternatively, target plates can be derivatized with particular antibodies to capture specific proteins from complex samples, and the captured proteins can be further analyzed by mass spectrometry. This approach has been introduced by Ciphergen as well as Intrinsic Bioprobes [U. A. Kiernan, K. A. Tubbs, K. Gruber, D. Nedelkov, E. E. Niederkofler, P. Williams and R. W. Nelson, Anal. Biochem., 301 (2002) 49; D. Nedelkov and R. W. Nelson, Anal. Chim. Acta, 423 (2000) 1; R. W. Nelson, D. Nedelkov and K. A. Tubbs, Anal. Chem., 72 (2000) 404A]. In this case, the method is referred to as SELDI (Surface-Enhanced Laser Desorption/Ionization).

Metal oxides have been proposed to fabricate LDI target plates. These so-called Metal Oxide Assisted Laser Desorption/Ionization (MOALDI) plates are characterized by the fact that the metal oxide acts as a light absorber, so that organic light absorbing matrices as usually employed in MALDI plates are not needed for the desorption/ionization of the samples [CHEN, CHEN, LIN, U.S. Pat. No. 7,122,792 B2]. In this case, the metal oxide layer is prepared by calcination of a sol containing a titanium salt and ionization takes place in the presence of citric acid. As in the case of DIOS (Desorption/Ionization On Silicon), the semiconductor substrate can absorb the light energy to ionize the sample [Suzdiak et al, U.S. Pat. No. 628,390]. Of course, it is important that the laser wavelength matches the bandgap of the semiconductor.

Nanostructures have already been proposed to modify a target plate. For example, Dubrow et al, [WO 2004/099068] have proposed to deposit, either by thermal growth or by direct transfer, nanofibers and nanofiber structures to obtain enhanced surface area. The term “nanofiber” refers there to a nanostructure typically characterized by at least one physical dimension being less than about 100 nm. In many cases, the region or characteristic dimension is along the smallest axis of the structure. Nanowires have also been used to modify target plates to fix a specimen and perform desorption/ionization while effectively transferring laser energy to the specimen to be irradiated in order to carry out mass spectrometry in the absence of a matrix [Choi, Pyun Patent WO 2005/088293] The purpose of using these nanowires modified plates is to do LDI for the analysis of small molecules.

Metal oxides can have strong specific interactions for example with phosphate groups. For example, Larsen et al have shown the highly selective enrichment of phosphorylated peptides from peptide mixtures using titanium dioxide particles [Larsen et al, Mol. Cell. Proteomics, 4 (2005) 873]. Iron oxide particles and iron oxide coated with different oxide e.g. ZrO₂, Al₂O₃, etc. . . . have also been used to adsorb molecules containing phosphate groups [Chen et al, J. Proteom. Res., 6 (2007) 887-893]. Additionally, metal oxides can act as photo-sensitisers on a target plate to oxidize or reduce molecules from the samples, as described recently [International patent application PCT/EP2008/000140]. In this case, the metal oxide nanoparticle is the locus of an electrochemical reaction such as an oxidation reaction, where the oxidized product can react with a sample for example with the aim to tag it.

Another issue in the design of a target plate is associated to the locus of the sample of the plate. Different strategies have been proposed to precisely place the sample in defined locations such as in an array of dots. In 1995, Schürenberg et al have proposed a concept based on the use of hydrophobic anchor spot within a hydrophilic surrounding where the sample can be dried [Schürenberg et al, U.S. Pat. No. 6,287,872]. In 2003, Schürenberg also proposed the use of a thin plastic cover of uniform thickness to take up the samples [Schürenberg et al, U.S. Pat. No. 7,825,465 B2]. In 2005, Brown et al have proposed to machine the metallic substrate of the plate to form circular groove or moat, prior to a polymer coating and to the opening of a spot in the center of the circular groove using laser photoablation [Brown, et al. U.S. Pat. No. 7,294,831B2].

Sintering of nanoparticles on a conductive substrate is a process widely used for the preparation of dye-sensitised solar cells, in particular for the fabrication of photo-anodes, see for example the generic work Graetzel et al [e.g. Graetzel et al, US2008/0006322 A1]. Sintering is a method for making objects from powder, such as here spots, by heating the material below its melting point so called solid-state sintering until the solid particles adhere to each other and to the substrate. Sintering is traditionally used for manufacturing ceramic objects. Particular advantages of this powder technology include the possibility of very high purity for the starting materials and their great uniformity preservation of purity due to the restricted nature of subsequent fabrication steps, stabilization of the details of repetitive operations by control of grain size in the input stages. When the powder is dissolved as slurry, the deposition of the wet slurry on a substrate can be carried out using liquid dispensers such as drop spotters or printing techniques such as screen printing. The major characteristic of sintered nanoparticles is to provide a mesoporous structure with an extremely high surface to volume ratio.

### SUMMARY OF THE INVENTION

The present invention relates to LDI target plates and/or MALDI plates where a layer of sintered nanoparticles, i.e. spherical particles of which the mean radius ranges from 1 to 500 nanometers, is deposited as an array of spots on a conductive substrate, to act first as a sorbing phase for the samples. Each spot is characterized by an extremely high sorbing capacity associated to a very large specific surface area for binding a large number of molecules having a specific interaction with the nanoparticles. In this way, when a drop of sample is deposited over the spot, the latter acts as an extractor to concentrate the sample within its porous structure. Also, each spot can act as a photosensitiser either to photo-oxidize or to photo-reduce molecules, from the sample or added to the sample. In this way, the spot-inherent photoelectrochemical activity can be used for tagging reactions, disulfide bridge reductions or ion source decay reactions. After adding a crystalline acid overlayer, the plate can be used as a classical matrix assisted laser desorption ionization (MALDI) device for mass spectrometry analysis. In the absence of matrix, the spot can be used directly for laser desorption ionization (LDI) mass spectrometry. These spot covered plates provide a very efficient tool to analyze by mass spectrometry biomolecules, and in particular such molecules specifically interacting with the spot, and to study the products of the photo-induced electron transfer reactions.

The invention provides a target plate for mass spectrometry according to claim 1. Optional features of the invention are set out in the dependent claims.

### BRIEF DESCRIPTION OF THE DRAWINGS

The invention will now be described by way of examples only, with reference to the accompanying drawings, in which:

FIG. 1 schematically shows the MALDI plate, with a spot of sintered nanoparticles according to the invention.

FIG. 2 schematically shows a fluidic setup for flowing diluted solutions over a spot.

FIG. 3 schematically shows how a spot acts a hydrophilic extractor phase when a drop of sample is deposited on it.

FIG. 4 shows a phosphopeptide interacting with a TiO₂ nanoparticle acting here as the extractor phase of phosphopeptides.

FIG. 5 shows an oxidation process with an irradiated TiO₂ nanoparticle acting here as an oxidant of an electron donor molecule and a reduction process with an irradiated TiO₂ nanoparticle acting here as a reductant of an electron acceptor molecule.

FIG. 6 shows the mass spectrum of the peptides resulting from the tryptic digestion of beta-casein obtained with the MALDI plate of FIG. 1.

FIG. 7 shows the mass spectrum of the peptides resulting from the tryptic digestion of beta-casein using a classical DHB-MALDI plate (DHB=2,5-dihydroxybenzoic acid).

FIG. 8 shows the mass spectrum obtained from diluted solutions of the tryptic digestion of beta-casein showing the enrichment factor for phosphorylated peptides using the MALDI plate of FIG. 1 after washing of the non-adsorbed peptides.

FIG. 9 shows the mass spectra of a tryptic digestion of beta-casein in the presence of an excess of a tryptic digestion of bovine serum albumin using selective on-plate enrichment on the MALDI plate of FIG. 1 (A) and using a classical DHB-MALDI plate (B).

FIG. 10 shows the mass spectra of a tryptic digestion of a commercial bovine milk sample using selective on-plate enrichment on the MALDI plate of FIG. 1 (A) and using a classical DHB MALDI plate (B).

FIG. 11 shows the mass spectrum obtained with the MALDI plate illustrated in FIG. 1 for a photo-induced tagging reaction of a cysteine-containing peptide following the oxidation by TiO₂ of DHB. The peak marked by a star (*) corresponds to the protonated form of the peptide (SSDQFRPDDCT), and that marked by (#) corresponds to the protonated tagged peptide, where the oxidized DHB is attached to the cysteine residue.

FIG. 12 shows the mass spectrum obtained with the MALDI plate illustrated in FIG. 1 for a photo-induced tagging reaction of a cysteine-containing peptide following the oxidation by TiO₂ of MOHQ (Methoxyhydroquinone). The peak marked by a star (*) corresponds to the protonated form of the peptide (SSDQFRPDDCT), and that marked by (#) corresponds to the protonated tagged peptide, where the oxidized MOHQ is attached to the cysteine residue.

FIG. 13 shows the mass spectrum obtained with the MALDI plate illustrated in FIG. 1 for a photo-induced tagging reaction of a cysteine-containing peptide following the oxidation by TiO₂ of HQ (hydroquinone). The peak marked by a star (*) corresponds to the protonated form of the peptide (SSDQFRPDDCT), and that marked by (#) corresponds to the protonated tagged peptide, where the oxidized HQ is attached to the cysteine residue.

FIG. 14 shows the nomenclature of fragment ions.

FIG. 15 shows the mass spectrum obtained with the plate illustrated in FIG. 1 for photo-induced in source decay of angiotensin I in the presence of glucose. The peak marked by a star (*) corresponds to the intact peptide, and those marked by (aₓ) corresponds to a-fragments.

FIG. 16 shows the mass spectrum obtained with the plate illustrated in FIG. 1 for photo-induced in source decay of oxidized bovine insulin β-chain in negative mode in the presence of glucose. The peak marked by a star (*) corresponds to the intact peptide, those marked by (aₓ) corresponds to a-fragments, and those marked by (cₓ) corresponds to c-fragments.

FIG. 17 schematically shows the mechanism of in-source photo induced reduction of disulfide bond using alcohol as electron donor.

FIG. 18 shows the structure of human insulin.

FIG. 19 shows the mass spectrum obtained with the plate illustrated in FIG. 1 for an in-source photo-induced disulfide bond reduction of human insulin in positive linear mode in the presence of citric acid.

FIG. 20 shows the mass spectrum obtained with plate illustrated in FIG. 1 for an in-source photo-induced disulfide bond reduction of human insulin in positive linear mode in the presence of glucose.

### DETAILED DESCRIPTION OF SPECIFIC EMBODIMENTS

Hereinafter, the present invention is described in more detail.

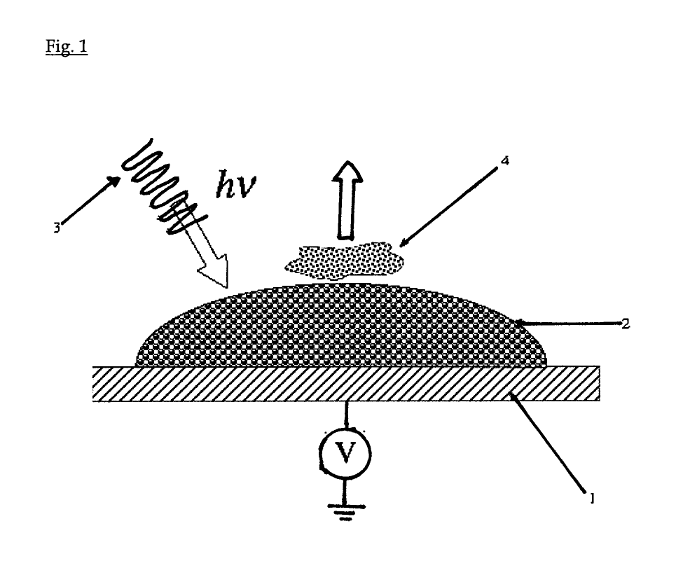

FIG. 1 shows a MALDI plate comprising a metallic substrate 1 and a spot of sintered nanoparticles 2. During the first step, the sample solution is placed on the spot where the sample is sorbed by the nanoparticles. In the case where the nanoparticles interact specifically with some molecules of the samples, a washing step is used to remove all unbound materials. For the analysis of these bound species, a desorbing step may be required before the addition of an organic acid matrix overlayer. In the case where no extraction by specific adsorption is required, the organic acid matrix overlayer is directly added after the sample deposition and drying. Upon irradiation by a laser 3, materials 4 including molecules from the sample and part of the matrix are ablated and released in the gas phase. The ions released in the gas phase are driven by an electric field to a mass spectrometer (not shown). In some cases, the deposition of a matrix overlayer may not be required, and upon irradiation by the laser 3, ionized molecules from the samples and/or ionized products of the photo-electrochemical reactions are released to the gas phase.

### Substrate 1 in FIG. 1:

The substrate can be a commercially available MALDI plate or a homemade target plate made of any conducting material. Typically, the target plate is made of aluminum, nickel or stainless steel. It can present a flat, unmodified surface, or a surface with engraved spots or annular groves to assist in locating samples in a known manner. Alternatively, the substrate can be made of a non-conductive material coated with a thin layer of conductive material such as one or more evaporated metals, or a semi-conducting material. Also, the conducting substrate can be a metallic foil placed in contact with a commercially available MALDI plate. A foil with a thickness below 250 μm is suitable, such as commercially available aluminum foil used for wrapping foods.

### Sintered Nanoparticle Spot 2 in FIG. 1:

Drops of a suspension of nanoparticles are applied on the substrate 1 to form an array of spots. Alternatively, a full layer of nanoparticles solution can be deposited on the substrate. After the solvent evaporation, the particles are heated below their melting temperature to sinter the nanoparticles. It is important to stress that according to Herring's equation, the smaller the nanoparticle radii the lower the melting temperature. The sintering experimental conditions are an important aspect of the present invention to ensure the highest sorbing capacity. Usually, an array of sintered nanoparticles spots is applied on the substrate 1 to allow a high throughput analysis of many samples. The nanoparticles can be metallic such as gold nanoparticles, metal-oxides such as TiO₂, ZnO, ZrO₂, Al₂O₃, etc., quantum dots such as CdS, CdSe, CdTe . . . or modified organic/inorganic materials and hybrids such as pigments.

### Sample Deposition in FIG. 1

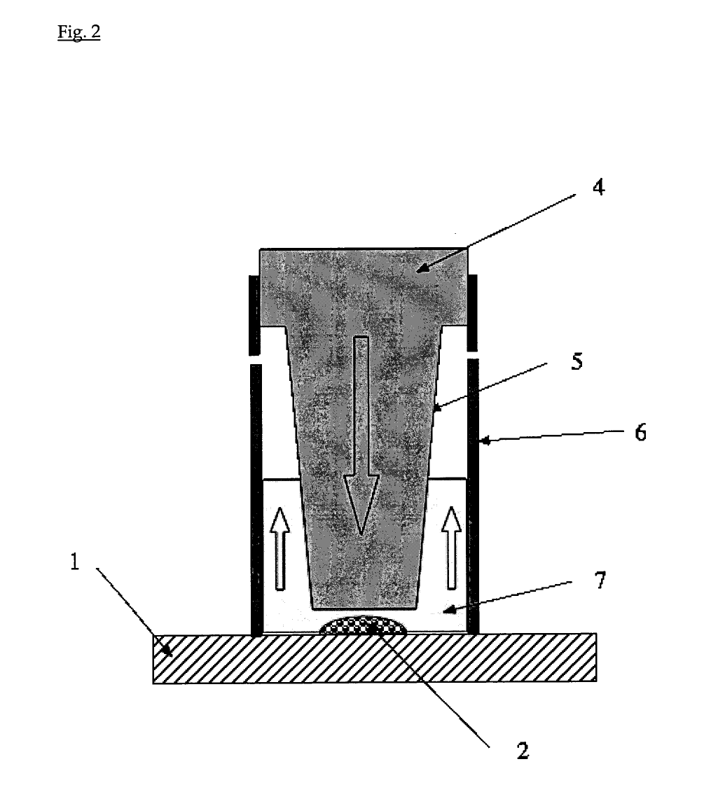

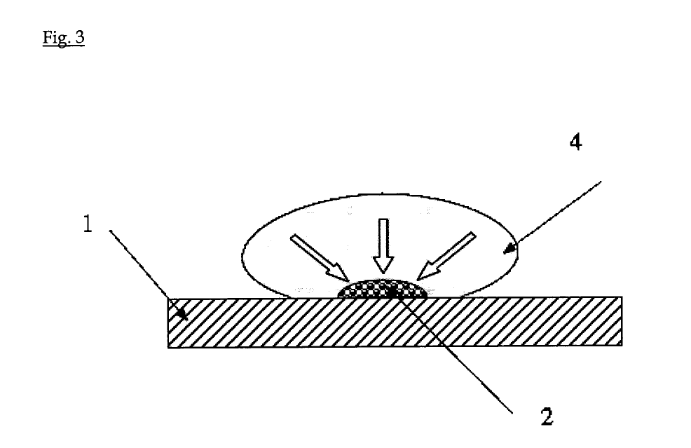

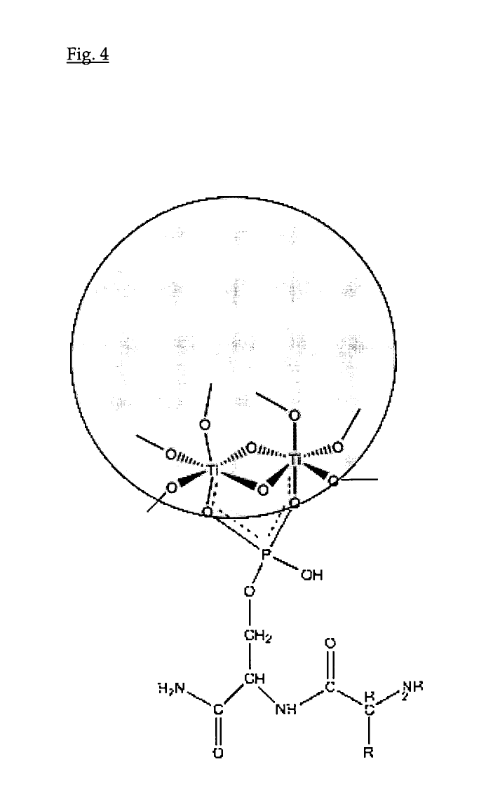

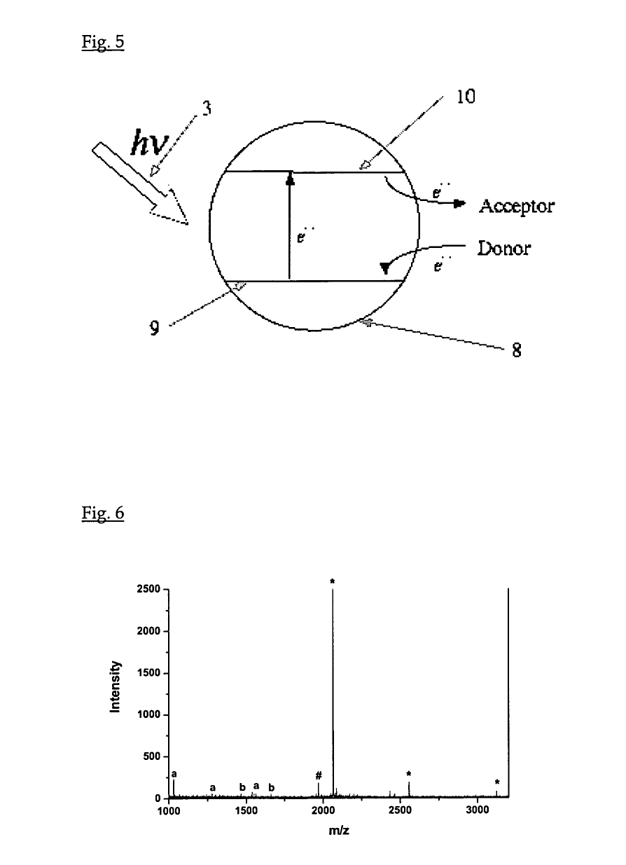

The sample can be deposited dropwise on the sintered nanoparticles acting as a sorbent phase as illustrated in FIG. 3. In the case of very diluted solutions, the full plate can be immersed completely in the solution, the sintered nanoparticles acting as an extractor phase. Alternatively, a fluidic device can be used on each spot to flow the diluted solution over the sintered nanoparticles as illustrated in FIG. 2. Here, the sample 4 is dispensed from a tip 5 over the sintered nanoparticles 2 to adsorb those molecules specifically interacting with the nanoparticles. A cylinder 6 fitted to the tip is used as a reservoir to hold the depleted sample solution 7. The sample solution 4 can be pumped in and out the tip repetitively to favor the adsorption of the interacting molecules. The depleted sample 7 is then pumped back in the tip 5, and the fluidic device is removed.

### Organic Acid and Matrix in FIG. 1

The matrix usually contains a crystalline acid, such as α-cyano-4-hydroxycinnamic acid (CHCA), sinapic acid (SA), 2,5-dihydroxybenzoic acid (DHB) or 2-(4-hydroxy phenylazo)-benzoic acid (HABA). The acid plays the role of the light absorber generating the gas phase release of ions and that of charge conductor transporting the charges, usually protons, from the sample plate 1 through the matrix. Alternatively, a simple acid such as citric acid (CA) can be used as an overlayer.

### On-Plate Enrichment

When a drop of sample solution is deposited on a hydrophilic spot, the sample concentrates on the spot during the drying process as shown in FIG. 3. When the nanoparticles interact specifically with some molecules from the sample, for example the specific interaction between TiO₂ and phosphorylated peptides as depicted in FIG. 4, then the frit layer can be used as a solid phase extractor for those molecules having an affinity for the nanoparticles. During the enrichment step, the samples are either placed as depicted in FIG. 3 or allowed to flow over the frit layer as depicted in FIG. 2 to pre-concentrate these interacting molecules. The plates are then washed to remove the non-adsorbing species. This washing step can be carried out with the fluidic device of FIG. 2. Then, the bound species are detached using a displacing chemical, for example a strong base for the case cited above.

### Photo-Induced Redox Reactions.

Using a pulsed light source 3 such as a UV laser (in the examples depicted here a Nd:YAG laser and a nitrogen laser) for the photo-ionization process, the nanoparticle 8 can absorb a photon promoting an electron from the valence band 9 to the conduction band 10, a process commonly referred to as photo-sensitisation. If an electron donor molecule donates an electron to the hole in the valence band, the donor is said to be oxidized. If an electron acceptor molecule accepts the electron promoted to the conduction band, the acceptor is said to be reduced. Those oxidized or reduced molecules following this photo-induced charge transfer reaction can in turn react with other molecules from the samples, and the product of these reactions can be analyzed by mass spectrometry. Based on the principle, these photo-induced redox reactions can be applied specifically to on-line peptide tagging, ion source decay, disulfide bond reduction or to any other redox reactions.

### Photoionisation Process.

Using a pulsed light source 3 such as a UV laser (in the examples depicted here a Nd:YAG laser and a nitrogen laser), the optical energy is absorbed by the light absorber in the matrix thereby creating an ejection of ionized matter comprising the sorbed molecules and part of the matrix, a process commonly referred to as MALDI ionization. Alternatively, the ionization can take place electrochemically if the light is absorbed by the nanoparticle.

### Example 1

### Phosphopeptide Sorption and Ionization from Sintered TiO₂ Nanoparticles

### TiO₂ Spot Preparation

A stainless steel plate is used as a substrate. A 0.4% (0.1%-1.0%) suspension of commercially available TiO₂ nanoparticles (Degussa P25) in water is prepared. Drops of the suspension are applied as a layer or an array of spots (˜2 μL) on a stainless steel plate. The drops are first allowed to dry, and then the plate is heated at 400° C. for one hour to form a spot of nanoparticles adhering to the substrate. The temperature and the duration of the sintering process depend on the nature and the size of the nanoparticles. The sintered nanoparticles are then cooled down to room temperature. The suspension can also be screen-printed directly on the metal plate.

### Phosphopeptide Sorption

Peptides are obtained by protein proteolysis. Proteins, including β-casein, protein mixture of β-casein and bovine serum albumine (BSA), milk samples, are digested with trypsin in 25 mM ammonium bicarbonate buffer (pH 8.0) at 37° C. for 12 hours. The ratio of trypsin to proteins is fixed as 1:30 (w:w).

Protein digests samples are first adsorbed on the sintered TiO₂ nanoparticles for ten minutes and then washed by a solution of 2,5-dihydroxybenzoic acid (DHB, 20 mg/ml in 50% acetonitrile/water, 0.1% TFA). Finally, 400 mM NH₃.H₂O is added and used to desorb phosphorylated peptides from the TiO₂ nanoparticles.

### MALDI Matrix Deposition and Mass Spectrometry Measurements

0.3 μL 2% TFA is added on the sample spot and dried at room atmosphere before the deposition of 0.5 μL DHB (20 mg/ml in 50% acetonitrile/water, 1% H₃PO₄) overlayer. The phosphorylated peptides captured on the TiO₂ matrix are analyzed on an Applied Biosystems 4700 Proteomics Analyzer in positive reflector mode. The MS spectrum of each spot is obtained by accumulation of 2000 laser shots with a laser intensity of 6200. As can be seen from FIG. 6 to FIG. 10, the selective enrichment has been demonstrated by the analysis of tryptic digests of β-casein and the mixture proteins.

### On-Plate Enrichment Results

Beta-casein, having well characterized phosphorylation sites, was used as a model at first to investigate the enrichment efficiency. The TiO₂ nanoparticles sintered on the plate shown in FIG. 1 were prepared to specifically capture the phosphorylated peptides from peptide mixtures of beta-casein digest, and then the captured phosphopeptides were analyzed by MALDI TOF MS directly.

FIG. 6 shows the mass spectrum of beta-casein digest on a TiO₂ spot. The purity of beta-casein is at least 90%, the impurities being alpha-casein. The concentration of digested peptides is 2 ng/μL (85 fmol/μL). The peaks marked by star (*) correspond to the three phosphorylated peptides of beta-casein (m/z: 3122.4, 2556.2, 2062.0), which have been extracted on the nanoparticles. The peak marked by (#) corresponds to the metastable loss of H₃PO₄ from the parent ions (*) (m/z: 1968.1). The peaks marked by (a) correspond to the doubly charged peaks of the three phosphorylated peptides (m/z: 1562.3, 1279.2, 1031.6). The peaks marked by (b) correspond to the phosphorylated peptides of α-casein (m/z: 1660.9, 1466.8). The spectrum shows selective enrichment of phosphorylated peptides by TiO₂ sintered nanoparticle deposited on the conductive substrate.

For comparison, FIG. 7 shows the mass spectrum of beta-casein digest on a classical stainless steel plate with a DHB matrix overlayer. The observed phosphorylated peptide peak is denoted by a star (*) (m/z: 2062.0).

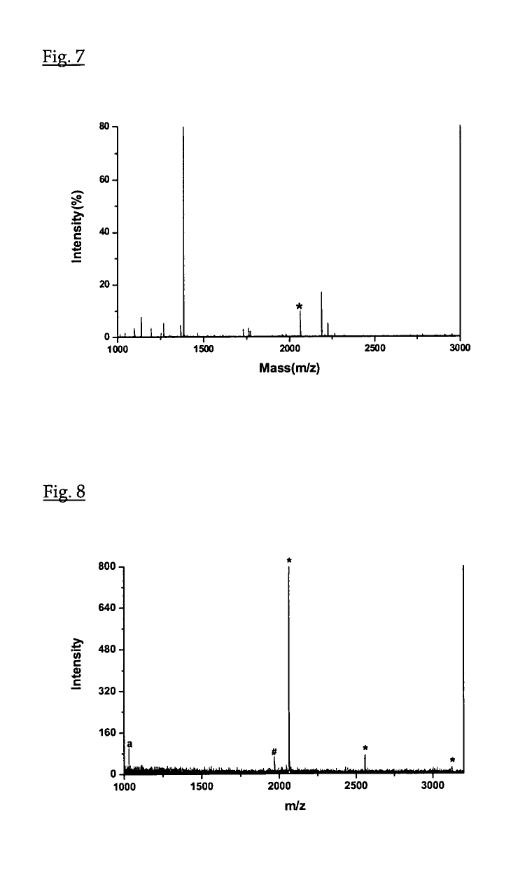

FIG. 8 shows the mass spectrum of the diluted β-casein digest after on-plate enrichment, the concentration of digested casein is 0.2 ng/μL (8.5 fmol/μL). The peaks marked by star (*) correspond to the three phosphorylated peptides of beta-casein (m/z: 3122.4, 2556.2, 2062.0). The peak marked by (#) corresponds to the metastable loss of H₃PO₄ from the parent ions (*) (m/z: 1968.1). The peak marked by (a) corresponds to the doubly charged ions of the phosphorylated peptides (m/z: 1031.6).

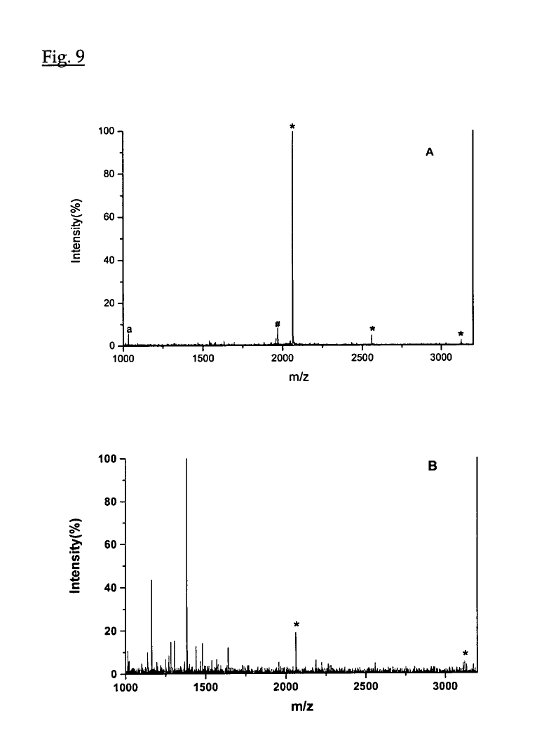

FIG. 9A shows the mass spectrum of the tryptic digest of a mixture of beta-casein and bovine serum albumin in the ratio of casein:BSA=1:50 (w:w) on TiO₂ sintered plate. The peaks marked by star (*) correspond to the three phosphorylated peptides of beta-casein (m/z: 3122.4, 2556.2, 2062.0). The peak marked by (#) corresponds to the metastable loss of H₃PO₄ from the parent ions (*) (m/z: 1967.3). The peak marked by (a) corresponds to the doubly charged ions of the phosphorylated peptides (m/z: 1031.6).

The spectrum shows only phosphorylated peptide peaks of beta-casein without obvious non-phosphorylated peptides. To illustrate the high selectivity of this TiO₂ on-plate enrichment, FIG. 9B shows the mass spectrum of the tryptic digest of a mixture of beta-casein and bovine serum albumin (casein:BSA=1:1) on classical stainless steel plate with a DHB overlayer. The observed phosphorylated peptide peaks are denoted by a star (*) (m/z: 3122.4, 2062.0). It can be observed that although the BSA concentration is not in excess as in FIG. 8A, the signal from only two phosphorylated peptides can be observed without being the major peaks.

FIG. 10A shows the mass spectrum of the tryptic digest of a commercial bovine milk sample on a TiO₂ spot. The peaks marked by star (*) correspond to the three phosphorylated peptides of beta-casein (m/z: 3122.0, 2556.2, 2062.0). The peaks marked by (#) correspond to the metastable loss of H₃PO₄ from the parent ions (*) (m/z: 1966.9, 3026.2). The peak marked by (a) corresponds to the doubly charged ions of the phosphorylated peptides (m/z: 1031.6). The peaks marked by (b) correspond to the phosphorylated peptides of α-casein (m/z: 1660.6, 1833.7, 1927.9, 1951.8).

The spectrum shows ten phosphorylated peptide peaks of alpha-casein and beta-casein, showing that the on-plate enrichment is highly specific to phosphorylated peptides in real sample applications. For comparison, FIG. 10B shows the mass spectrum of the tryptic digest of the same milk sample on a classical stainless steel plate with a DHB matrix overlayer The observed phosphorylated peptide peak is denoted by a star (*) (m/z: 2062.0).

### Example 2

### Cysteinyl Peptide Tagging Using Photo-Oxidation of Redox Tags

The TiO₂ spot preparation is similar to that of example 1.

A single cysteine-containing peptide (SSDQFRPDDCT) has been used as a model peptide. The peptide was diluted in water and kept as a stock solution. Before each experiment, aliquots were mixed respectively with DHB, MOHQ and HQ. The peptide concentration in the mixture was 5 ng/μl, i.e a concentration of 4 μM. The molar ratio peptide to redox tags was 1:1. 0.4 μL of the mixture solution was deposited on the sintered nanoparticle spots. The spot area was about 7 mm². The sample/redox mixture was left to dry for 10 min in the dark to avoid spurious redox reactions, and then covered by an overlayer of CHCA dissolved in a solution of acetonitrile 50%/water 50% and left to dry for 5 min.

The mass spectra were obtained with an Applied Biosystems 4700 Proteomics Analyzer having a laser wavelength of 355 nm in positive reflector mode.

### Oxidative Tagging Results as in Example 2

When the nanoparticles are able to act as photo-sensitisers, as in the case of TiO₂ sintered nanoparticles deposited on a conductive substrate and irradiated by the light source 3 in FIG. 1, then electron transfer reactions can occur between the nanoparticles and some target molecules being either electron donors or electron acceptors. For example, if an electron donor is added to the sample such as 2,5-dihydroxybenzoic acid (DHB), hydroquinone (HQ) or 2-methoxyhydroquinone (MOHQ), it can be oxidized and the oxidized form can undergo an addition reaction with cysteine-containing peptides. This method provides a way to tag cysteinyl peptides allowing the counting of cysteine moieties in a peptide. Here, the sintered nanoparticles offer a very large specific surface area with a very large surface/volume ratio enabling a very large oxidation capacity, or respectively a very large reduction capacity.

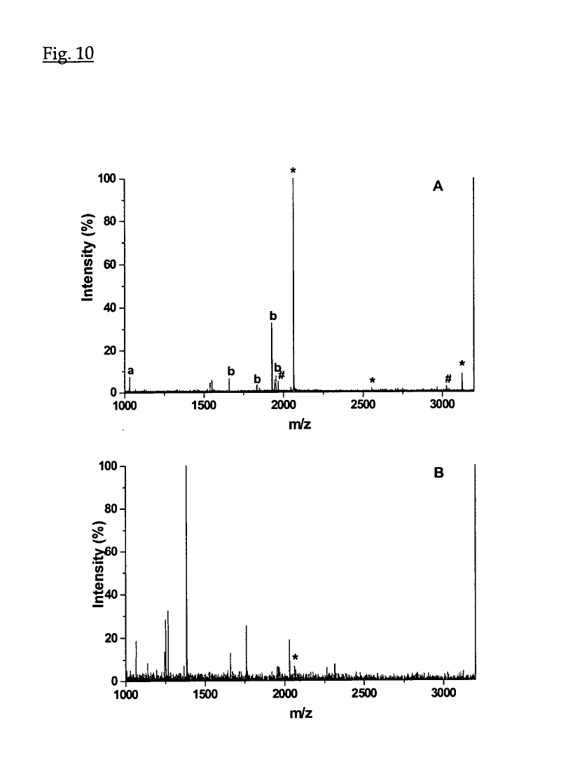

FIG. 11 shows the mass spectrum obtained from a TiO₂ nanoparticle spot for a photo-induced tagging reaction of a cysteine-containing peptide (1.5 pmol deposited) following the oxidation by TiO₂ of DHB (molar ratio peptide/DHB 1:1). The peak marked by a star (*) corresponds to the protonated form of the peptide (SSDQFRPDDCT), and that marked by (#) corresponds to the protonated tagged peptide, where the oxidized DHB is attached to the cysteine residue. These data clearly show that the present invention permits the study of oxidized molecules and the products of the reactions of the oxidized molecules by mass spectrometry.

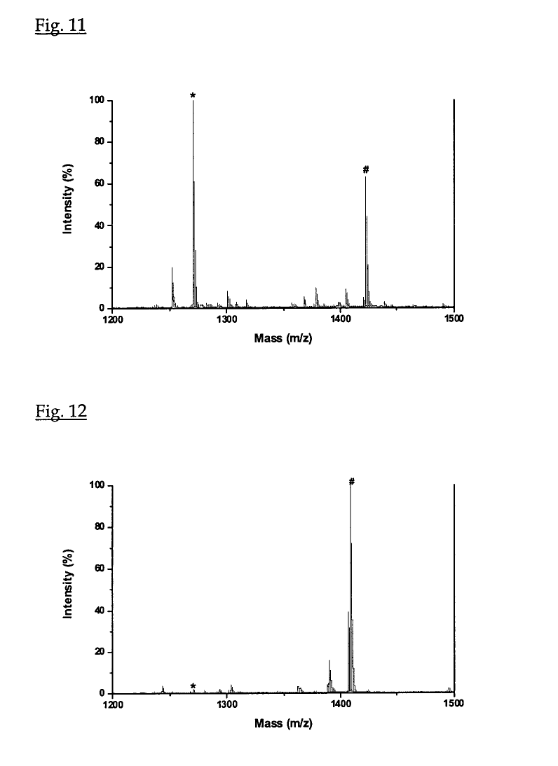

FIG. 12 shows the mass spectrum obtained from a TiO₂ nanoparticle spot for a photo-induced tagging reaction of a cysteine-containing peptide (1.6 pmol deposited) following the oxidation by TiO₂ of MOHQ (molar ratio peptide/MOHQ 1:1). The peak marked by a star (*) corresponds to the protonated form of the peptide (SSDQFRPDDCT), and that marked by (#) corresponds to the protonated tagged peptide, where the oxidized MOHQ is attached to the cysteine residue.

FIG. 13 shows the mass spectrum obtained from a TiO₂ nanoparticle spot for a photo-induced tagging reaction of a cysteine-containing peptide (1.6 pmol deposited) following the oxidation by TiO₂ of HQ (molar ratio peptide/HQ 1:1). The peak marked by a star (*) corresponds to the protonated form of the peptide (SSDQFRPDDCT), and that marked by (#) corresponds to the protonated tagged peptide, where the oxidized HQ is attached to the cysteine residue.

### Example 3

### Photo-Induced Peptide in-Source Decay

The TiO₂ spot preparation is similar to that of example 1.

Angiotensin I and oxidized bovine insulin β-chain have been employed as model peptides. The peptides were diluted in water and kept as a stock solution with a concentration of 70 μM and 7 μM respectively. 1 μL of the solution was deposited on the sintered nanoparticle spots. The solution was left to dry for 10 min in ambient condition, and then covered by an overlayer of glucose dissolved in a solution of water (10 mg/ml) and left to dry for 5 min.

The mass spectra were obtained with a Bruker Microflex having a laser wavelength of 337 nm in both positive and negative reflector modes.

Photo-Induced Peptide in-Source Decay Results as in Example 3

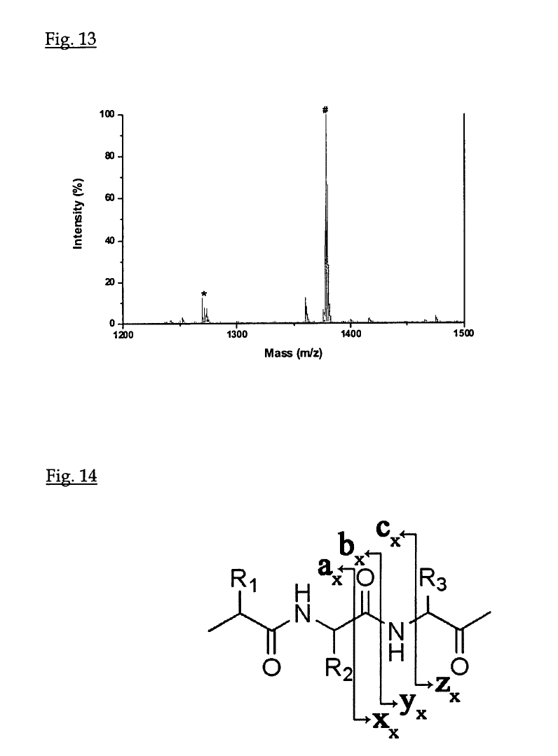

In source decay is a fragmentation process occurring in the ion source rapidly after the laser shot. Being coupled with MALDI-TOF MS, it provides a useful method for sequencing peptides and proteins. Compared with the conventional mass spectrometric degradation, ISD is of great advantage in directly obtaining the amino acid sequence information of intact molecules without pre-digestion, which is useful in the top-down sequencing approach. Generally, ISD of peptides leads to c- and z-fragment ions corresponding to the reductive cleavage of the N—C bonds on the peptide backbone according to Biemann's nomenclature as depicted in FIG. 14. However, a- and x-fragment ions are difficult to be observed in ISD process. In this invention, we propose an alternative strategy to drive very efficient in-source photo-induced redox reactions under UV laser irradiation on a steel plate with TiO₂ nanoparticles sintered spots shown in FIG. 1 to achieve efficient peptide in source decay in the presence of glucose. In this case, both a/x and c/z-series fragment ions are observed. Furthermore, the spot can be used directly for laser desorption ionization (LDI) mass spectrometry in the absence of organic matrix.

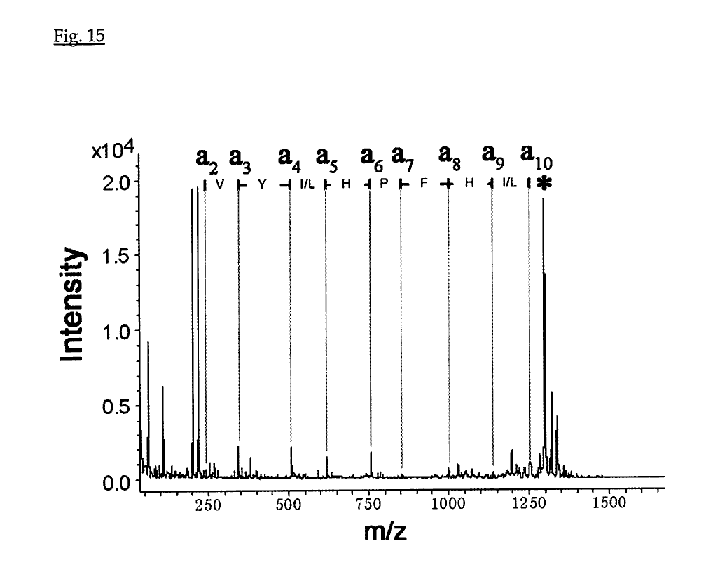

TiO₂ used as a photosensitive substrate to assist the sample desorption/ionization is very useful for the analysis of smaller molecules. FIG. 15 shows the mass spectrum obtained with the TiO₂ sintered nanoparticle plate illustrated in FIG. 1 for the in-source decay of angiotensin I in the presence of glucose in positive mode. The peak marked by a star (*) corresponds to the intact peptide, and those marked by (aₓ) correspond to a-fragments. We can read the whole amino-acid sequence of the peptide from this mass spectrum. The result shows that the present invention provides high signal-to-noise ratio to analyze peptides in lower MW regions.

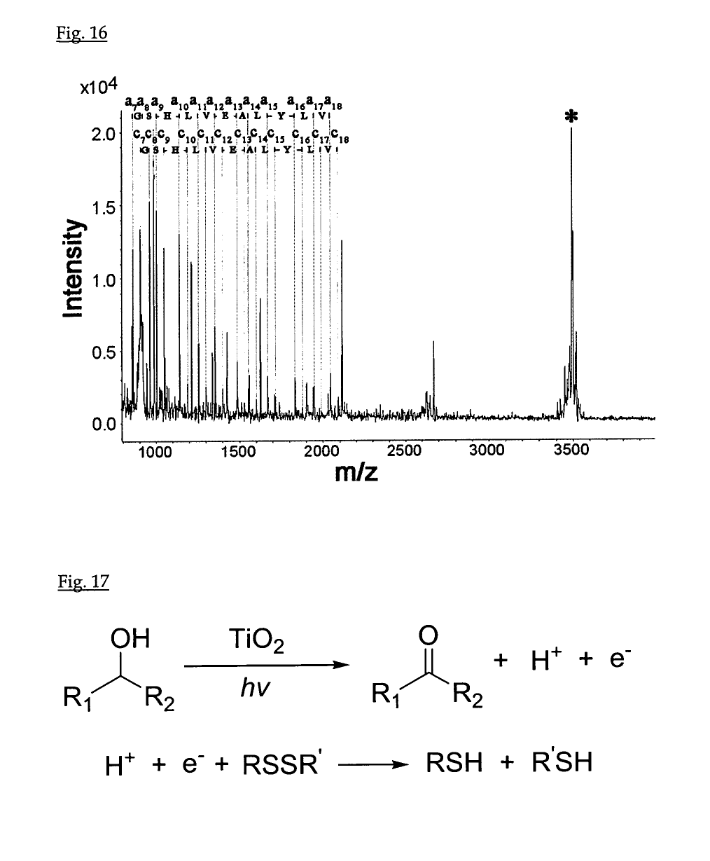

FIG. 16 shows the mass spectrum obtained with the TiO₂ nanoparticle sintered plate illustrated in FIG. 1 in the presence of glucose for the in-source decay of oxidized bovine insulin β-chain in negative mode. The peak marked by a star (*) corresponds to the intact peptide, those marked by (aₓ) corresponds to a-fragments, and those marked by (cₓ) corresponds to c-fragments. More fragments information is obtained for the large peptide analysis in negative mode. These data clearly show that the present invention permits the study of peptide in source decay induced from c-series ions together with a-series ions by mass spectrometry.

### Example 4

### Protein Disulfide Mapping Using in-Source Photo-Reduction of Disulfide Bond

The TiO₂ spot preparation is similar to that of example 1.

Human insulin has been employed as a model protein. The protein was diluted in water and kept as a stock solution with a concentration of 17 μM. 1 μL of the solution was deposited on the sintered nanoparticle spots. The solution was left to dry for 10 min in ambient condition, and then covered by an overlayer of glucose dissolved in a solution of water (10 mg/ml) and left to dry for 5 min.

The mass spectra were obtained with a Bruker Microflex having a laser wavelength of 337 nm in positive linear mode.

### Photo Reduction Induced Disulfide Mapping Result as in Example 4

Under the irradiation by the light source 3 in FIG. 1, the TiO₂ nanoparticles can absorb photons generating electron-hole pairs and therefore acting as photosensitisers to drive very efficiently electron transfer reactions. For example, in the presence of glucose as a hole scavenger, this sintered plate shown in FIG. 1 can be used for in-situ photo-induced reduction reaction without organic matrix to selectively cleave disulfide-bridged proteins on the target plate and further applied in disulfide mapping of proteins containing disulfide bonds. Herein, the sintered nanoparticles offer a very strong reduction capacity, thus enable the determination of the reduction products of a given molecule by mass spectrometry in the absence of organic matrices.

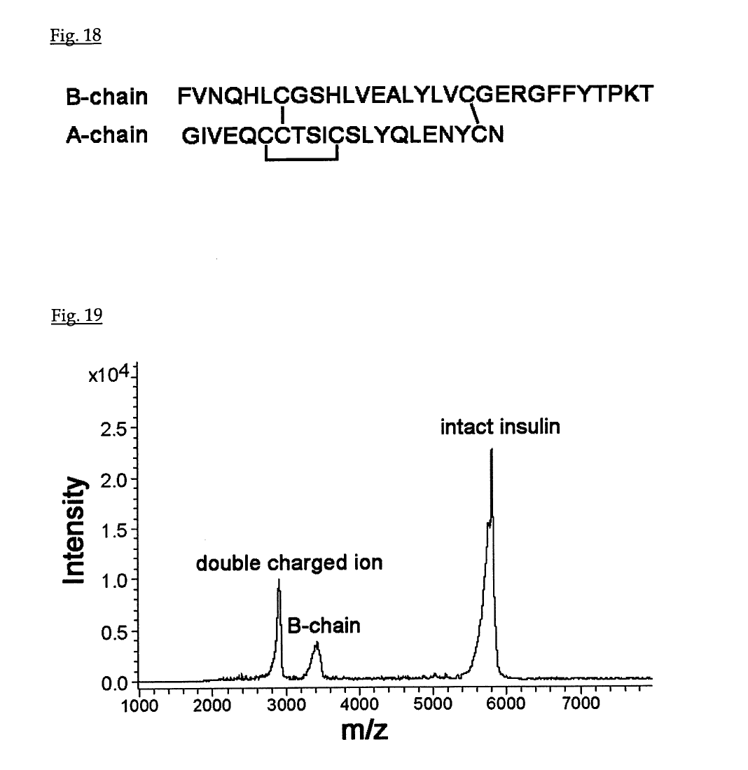

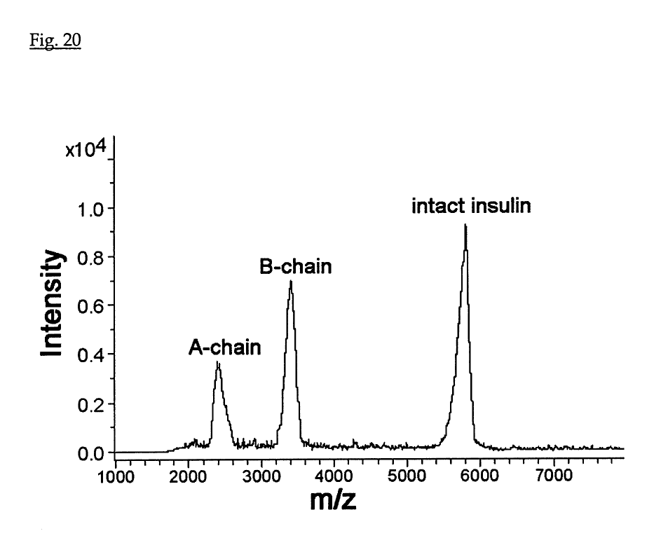

Cleavages of disulfide bonds are necessary for the rapid sequencing of peptides containing disulfide bonds. In the present invention, the disulfide bond reduction is confirmed from the mass spectra of human insulin on the TiO₂ nanoparticles sintered plate shown in FIG. 1 in the presence of glucose. Insulin consists of two peptide chains i.e. A- and B-chains (FIG. 18). When the disulfide bonds are reduced, two ions derived from A- and B-chain can be detected (FIG. 19).

FIG. 19 shows the mass spectrum obtained with the TiO₂ sintered plate illustrated in FIG. 1 for an in-source photo-induced disulfide bond reduction of human insulin in positive linear mode using citric acid as electron donor. In the mass spectrum, only B-chain is observed, showing that the reductive property is not strong enough. Considering that carbohydrates and C₂-C₆ polyols rapidly scavenge the holes in aqueous anatase nanoparticles, it is anticipated that the reduction could be enhanced by the addition of the hole scavengers, herein glucose as an example, on the TiO₂ sintered plate. FIG. 20 shows the mass spectrum obtained with the TiO₂ nanoparticle sintered plate illustrated in FIG. 1 for a photo-induced disulfide bond reduction of human insulin in positive linear mode using glucose as electron donor. In the presence of glucose, both inter-disulfide bridges are cleaved and the A- and B-chains are detected, demonstrating that the TiO₂ nanoparticle sintered spots with glucose enable efficient on-plate reduction reaction of disulfide bonds without any pre-treatment of the intact peptides.

### Advantages of the Present Method

Compared to other methods where sorbing phases are deposited on the MALDI plates (see for example U.S. Pat. No. 6,825,832 B2), the major advantage of the present invention is the extremely high sorbing capacity associated to the very large specific surface area and the very large specific to geometric area ratio. Indeed for a sintered nanoparticles layer of thickness h, the ratio specific surface area/geometric surface area is 3h/r for a hard sphere model where r is the radius of the nanoparticles. For example, for a layer thickness of 100 microns and a nanoparticle radius of 10 nanometers, the specific surface area is 30′000 times larger that the geometric area. This characteristic is unique to mesoporous structures. The present invention therefore provides an enhanced sorption compared to polymer or amorphous gel based phases, or even to nanowire modified plates.

The second major advantage of the present invention is to combine into one phase a sorbing phase to deposit the sample and an extractor phase to selectively enriched molecules having a high affinity. The samples can then directly be placed on the sintered nanoparticles layer, the non binding species being washed away after the binding process.

The third major advantage of the present invention is to combine into one phase a sorbing phase to deposit the sample and a reacting phase with a very high surface to volume ratio, for example when using quantum dot nanoparticles for redox reactions. This provides a very large capacity for redox reactions with molecules in the sample or added to the sample. By comparison with the use of nanoparticles simply incorporated in the matrix [International Patent Application PCT/EP2008/000140], here the present sintered nanoparticles when used for the tagging of cysteinyl peptides provide much higher tagging efficiency with lower concentrations of redox tags.

Compared to MALDI plates modified by nanowires and other nanostructures, the major advantage here stems from the simplicity of the fabrication of the frit layer, i.e spotting an aqueous suspension of nanoparticles and sintering them. In the case of silicon nanowires, Choi and Pyun [WO 2005/088293] used SiCl₄ at 500° C. via chemical vapor deposition to form nanowire spots. Alternatively, a suspension of nanowires was mixed with the sample in a suspension. This method excludes any pre-concentration or washing steps. The major advantage of the sintering process is to prepare adherent frit layers, where the sample solution can be placed. Specific molecules can be retained by specific adsorption whilst the undesired species such as salt can be removed by a washing step.

Another advantage of the present invention is that the nanoparticle sintered spot on the plate provides a very large porous network. In this way, when a drop of sample is deposited over the spot, the latter acts as an extractor to concentrate the sample within its porous structure and therefore provides an enhanced sorption rate compared to other methods.

Additionally, the nanoparticle sintered spot acts as a light absorber for the desorption/ionization of the samples. The plate in this invention can be used to carry out mass spectrometry for the analysis of small molecules without using an organic matrix.

The present invention provides a photosensitive plate that shows specific advantages to carry out in-source redox reactions during laser desorption ionization mass spectrometry. Under the laser illumination, each spot can act as a photosensitiser either to photo-oxidize or to photo-reduce molecules from the sample or added to the sample very efficiently. In some cases, these in-source photo-induced redox reactions can provide very useful information for the analysis of sample structures, such as the information about cysteine from the oxidation tagging reactions, the information of fragment ions from the ion source decay and the information about disulfide bridges from the reduction of disulfide bonds. Secondly, the present invention can be employed in the study of redox reaction mechanisms by the direct analysis of the products generated on the interface between solid and gas phase in nanoseconds, which may instantaneously existed or unstable in ambient condition. Furthermore, the present invention can be employed in the study of in-vivo biomolecule redox reactions, which are largely related to the metabolism and aging of cells and organisms.

1. A plate for matrix-assisted laser desorption ionization (MALDI) mass spectrometry comprising an electrically conductive substrate at least partially covered with sintered nanoparticles, deposited as an array of individual spots, for use as a sorbing phase for a sample, and for supporting ionization of sorbed samples molecules covered by or present in an overlayer or matrix, the overlayer or matrix comprising at least a light absorber and a charge carrier acid.

2. A plate according to claim 1 for use with a sample including molecules with which the sintered nanoparticles have specific interactions and are arranged to act as an extractor phase.

3. A plate according to claim 1 wherein the sintered nanoparticles have a large surface to volume ratio sufficient to allow a photochemical reaction with target molecules present in the sample or added to the sample through charge transfer reactions.

4. A plate according to claim 1, wherein the nanoparticles are made of one or more metallic oxides such as TiO₂, Al₂O₃, ZnO, SiO₂, Fe₃O₄, ZrO₂, Nb₂O₅.

5. A plate according to claim 1, wherein the nanoparticles are quantum dots such as CdS, CdSe, ZnO or like materials, able to be photo-sensitized during the photo-ionization process.

6. A plate according to claim 1, wherein the nanoparticles are core-shell nanoparticles.

7. A plate according to claim 1, wherein the nanoparticles are spherical and have a mean radius between 1.5 and 50 nanometers.

8. A plate according to claim 1, wherein the nanoparticles are deposited on the substrate by screen printing.

9. A plate according to claim 1, wherein the nanoparticles are deposited on the substrate by rotogravure printing.

10. A plate according to claim 1, wherein each spot of sintered nanoparticles covers a surface area of the substrate ranging from 25 square micrometers to 25 square millimeters.

11. A plate according to claim 1, wherein the sintered nanoparticles are in a layer ranging from 50 nanometres to 50 micrometres in thickness.

12. A plate according to claim 1, wherein the sorbing nanoparticles specifically bind to phosphorylated peptides.

13. A plate according to claim 1, wherein the sorbing nanoparticles are derivatized by hydrophobic molecules so as to specificially bind other hydrophobic molecules such as peptides.

14. A plate according to claim 1, wherein the sorbing nanoparticles are derivatized by a specific ligand so as to specifically bind target molecules.

15. A plate according to claim 1, wherein the electrically conductive substrate comprises stainless steel, aluminum, nickel, zinc, copper, silicon, tin-indium oxide on glass or a conductive/semi-conductive polymer.

16. A plate according to claim 1, wherein the electrically conductive substrate is a thin foil placed in contact with another conducting material.

17. A method of preparing the plate according to claim 1, comprising the steps of: (a) preparing a nanoparticle suspension, (b) applying this suspension to the conductive substrate, (c) curing so as to obtain sintering of the nanoparticles to ensure their mutual adhesion and their adhesion to the substrate.

18. A method according to claim 17, wherein the applying step comprises a drop spot technique, spraying, electro-spraying, dip-coating, screen-printing, rotogravure printing, spin-coating or plasma spraying.

19. A method according to claim 17, wherein a sample is applied to the sintered nanoparticles.

20. A method according to claim 19 wherein the step of applying the sample comprises flowing a sample solution over the sintered nanoparticles using a fluidic device in order to enrich molecules having a specific interaction with the nanoparticles.

21. A method according to claim 20 wherein the molecules to be enriched are selected from phosphorylated peptides, oligonucleotides and DNA.

22. A method of use of a plate according to claim 1, wherein molecules from the sample or added to the sample are photo-oxidized by the sintered nanoparticles for the mass spectrometry analysis of the oxidized molecules or reaction products of those oxidized molecules.

23. A method of use of a plate according to claim 1, wherein molecules from the sample or added to the sample are photo-reduced by the sintered nanoparticles for the mass spectrometry analysis of the reduced molecules or reaction products of those reduced molecules.

24. A method of use of a plate according to claim 1, wherein an electron donor or electron acceptor molecule is added to the sample, which molecule, when oxidized or reduced respectively, after the photochemical reactions, oxidizes or reduces respectively and cleaves molecules.

25. A method according to claim 24, wherein the molecules being cleaved are selected from oligomers, oligosaccharides and biomolecules including peptides or oligonucleotides.
